(19) United States
(12) Patent Application Publication
(10) Pub. No.: US 2013/0329111 A1
(43) Pub. Date: Dec. 12, 2013

(54) CONTEXTUAL HELP GUIDE

(71) Applicant: Samsung Electronics Co., Ltd., Suwon (KR)

(72) Inventors: Prashant Desai, San Francisco, CA (US); Jesse Alvarez, Oakland, CA (US)

(73) Assignee: Samsung Electronics Co., Ltd.

(21) Appl. No.: 13/912,691

(22) Filed: Jun. 7, 2013

Related U.S. Application Data
(60) Provisional application No. 61/781,712, filed on Mar. 14, 2013.
(60) Provisional application No. 61/657,663, filed on Jun. 8, 2012.

(51) Int. Cl. H04N 5/232

(52) U.S. Cl. CPC H04N 5/23293
USPC 348/333.02

(57) ABSTRACT

A method of providing contextual help guidance information for camera settings based on a current framed image comprises displaying a framed image from a camera of an electronic device, performing contextual recognition for the framed image on a display of the electronic device, identifying active camera settings and functions of the electronic device, and presenting contextual help guidance information based on the contextual recognition and active camera settings and functions.

### CROSS-REFERENCE TO RELATED APPLICATIONS

This application claims the priority benefit of U.S. Provisional Patent Application Ser. No. 61/657,663, filed Jun. 8, 2012, and U.S. Provisional Patent Application Ser. No. 61/781,712, filed Mar. 14, 2013, both incorporated herein by reference in their entirety.

### TECHNICAL FIELD

One or more embodiments relate generally to taking photos, and in particular to, providing contextual help guidance information based on a current framed image, on an electronic device.

### BACKGROUND

With the proliferation of electronic devices such as mobile electronic devices, users use the electronic devices for taking photos and photo editing. Users that need help or guidance for photo capturing need to seek guidance outside of the image capturing live view.

### SUMMARY

One or more embodiments relate generally to providing contextual help guidance based on a current framed image. One embodiment provides using contextual help guidance information for capturing a current framed image.

In one embodiment, a method of providing contextual help guidance information for camera settings based on a current framed image comprises displaying a framed image from a camera of an electronic device, performing contextual recognition for the framed image on a display of the electronic device, identifying active camera settings and functions of the electronic device, and presenting contextual help guidance information based on the contextual recognition and active camera settings and functions.

Another embodiment comprises an electronic device. The electronic device comprising a camera, a display and a contextual guidance module. In one embodiment, the contextual guidance module provides contextual help guidance information based on a current framed image via a camera of the electronic device. The contextual guidance module performs contextual recognition for the current framed image on the display, identifies active camera settings and functions of the electronic device, and presents contextual help guidance information based on the contextual recognition and active camera settings and functions.

One embodiment comprises a computer program product for providing contextual help guidance information for camera settings based on a current framed image. The computer program product comprising a tangible storage medium readable by a computer system and storing instructions for execution by the computer system for performing a method. The method comprising displaying a framed image from a camera of an electronic device. Contextual recognition for the framed image on a display of the electronic device is performed. Active camera settings and functions of the electronic device are identified. Contextual help guidance information is presented based on the contextual recognition and active camera settings and functions.

Another embodiment comprises a graphical user interface (GUI) displayed on a display of an electronic device. The GUI comprises a personalized contextual help menu including one or more selectable references related to a framed image obtained by a camera of the electronic device based on one or more of identified location information and object recognition. Upon selection of one of the references, information is displayed on the GUI.

These and other aspects and advantages of the one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIGS. 1A-B show block diagrams of architecture on a system for providing contextual help guidance information for camera settings based on a current framed image with an electronic device, according to an embodiment.

FIGS. 2A-D shows examples of displays for providing contextual help guidance information for camera settings based on a current framed image with an electronic device, according to an embodiment.

FIG. 3 shows a flowchart of a process for providing contextual help guidance information for camera settings based on a current framed image with an electronic device, according to an embodiment.

FIG. 4 is a high-level block diagram showing an information processing system comprising a computing system implementing an embodiment.

FIG. 5 shows a computing environment for implementing an embodiment.

FIG. 6 shows a computing environment for implementing an embodiment.

FIG. 7 shows a computing environment for providing contextual help guidance information, according to an embodiment.

FIG. 8 shows a block diagram of an architecture for a local endpoint host, according to an example embodiment.

### DETAILED DESCRIPTION

The following description is made for the purpose of illustrating the general principles of the one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to using an electronic device for providing contextual help guidance information for assistance with, for example, camera settings, based on a current framed image. One embodiment provides multiple selections for contextual help guidance.

In one embodiment, the electronic device comprises a mobile electronic device capable of data communication over a communication link such as a wireless communication link. Examples of such mobile device include a mobile phone device, a mobile tablet device, smart mobile devices, etc.

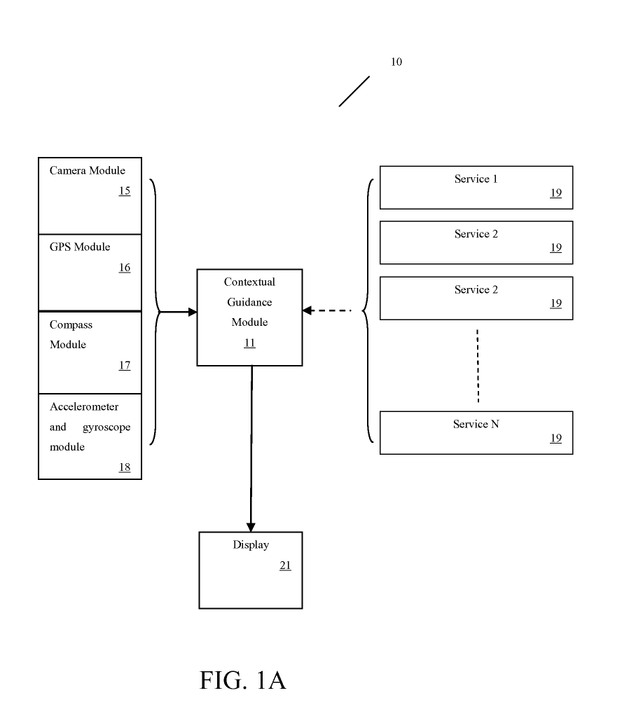

FIG. 1A shows a functional block diagram of an embodiment of contextual help guidance system 10 for providing contextual help guidance information for camera settings based on a current framed image with an electronic device (such as mobile device 20 as shown in FIG. 1B), according to an embodiment.

The system 10 comprises a contextual guidance module 11 including a subject matter recognition module 12 (FIG. 1B), a location-based information module 13 (FIG. 1B), an active camera setting and function module 14 (FIG. 1B), an environment and lighting module 23 and a time and date identification module 24 (FIG. 1B). The contextual guidance module 11 utilizes mobile device hardware functionality including one or more of: camera module 15, global positioning satellite (GPS) receiver module 16, compass module 17, and accelerometer and gyroscope module 18.

The camera module 15 is used to capture images of objects, such as people, surroundings, places, etc. The GPS module 16 is used to identify a current location of the mobile device 20 (i.e., user). The compass module 17 is used to identify direction of the mobile device. The accelerometer and gyroscope module 18 is used to identify tilt of the mobile device.

The system 10 provides for recognizing the currently framed subject matter, determining current location, active camera settings and functions, environment and lighting, and time and date, and based on this information, provides contextual help guidance information for the current framed image for assistance and possible use for assistance in taking a photo of the subject matter currently framed using a camera of the mobile device 20. The system 10 provides a simple, fluid, and responsive user experience.

Providing contextual help guidance information for a current framed image with an electronic device (such as mobile device 20 as shown in FIG. 1B) comprises integrating information including camera settings data (e.g., F-stop data, flash data, shutter speed data, lighting data, etc.), location data, sensor data (i.e., magnetic field, accelerometer, rotation vector), time and date data, etc. For example, Google Android mobile operating system application programming interface (API) components providing such information may be employed.

In one embodiment, locating and obtaining contextual help information and guidance based on location data, compass data, object information, subject recognition, and keyword information are pulled from services 19 from various sources, such as cloud environments, networks, servers, clients, mobile devices, etc. In one embodiment, the subject matter recognition module 12 performs object recognition for objects being viewed in a current frame based on, for example, shape, size, outline, etc. in comparison of known objects stored, for example, in a database or storage depository.

In one embodiment, the location-based information module 13 obtains the location of the mobile device 20 using the GPS module 16 and the information from the subject matter recognition module 12. For example, based on the GPS location information and subject matter recognition information, the location-based information module 13 may determine that the location and place of the current photo frame is a sports stadium (e.g., based on the GPS data and the recognized object, the venue may be determined). Similarly, if the current frame encompasses a famous statue, based on GPS data and subject matter recognition, the statue may be recognized and location (including, elevation, angle, lighting, time of day, etc.) may be determined. Additionally, rotational information from the accelerometer and gyroscope module 18 may be used to determine the position or angle of the camera of the electronic mobile device 20. The location information may be used for determining types of contextual help guidance to obtain and present on a display of the mobile device 20.

In one embodiment, the active camera setting and function module 14 detects the current camera and function settings (e.g., flash settings, focus settings, exposure settings, etc.). The current camera settings and focus settings information are used in determining types of contextual help guidance to obtain and present on a display of the mobile device 20.

In one embodiment, the environment and lighting module 23 detects the current lighting and environment based on a current frame of the camera of the mobile device 20. For example, when the current frame includes an object in the daytime when the weather is partly cloudy, the environment and lighting module 23 obtains this information based on, for example, a light sensor of the camera module 15. The environment and lighting information may be used for determining types of contextual help guidance to obtain and present on a display of the mobile device 20.

In one embodiment, the time and date identification module 24 detects the current time and date based on the current time and date set on the mobile device 20. In one embodiment, the GPS module 16 updates the time and date of the mobile device 20 for various display formats on the display 21 (e.g., calendar, camera, headers, etc.). The time and date information may be used for determining types of contextual help guidance to obtain and present on a display of the mobile device 20.

In one embodiment, the information obtained from the subject matter recognition module 12, location-based information module 13, the active camera setting and function module 14, the environment and lighting module 23 and the time and date module 24 may be used for searching one or more sources of guide and help information that is contextually based on the obtained information and relevant to the current frame and use of the mobile device 20. The contextually based help and guidance information is then pulled to the mobile electronic device 20 via the transceiver 25. The retrieved help and guidance information are displayed on the display 21. The user may then select and use the guidance and help information.

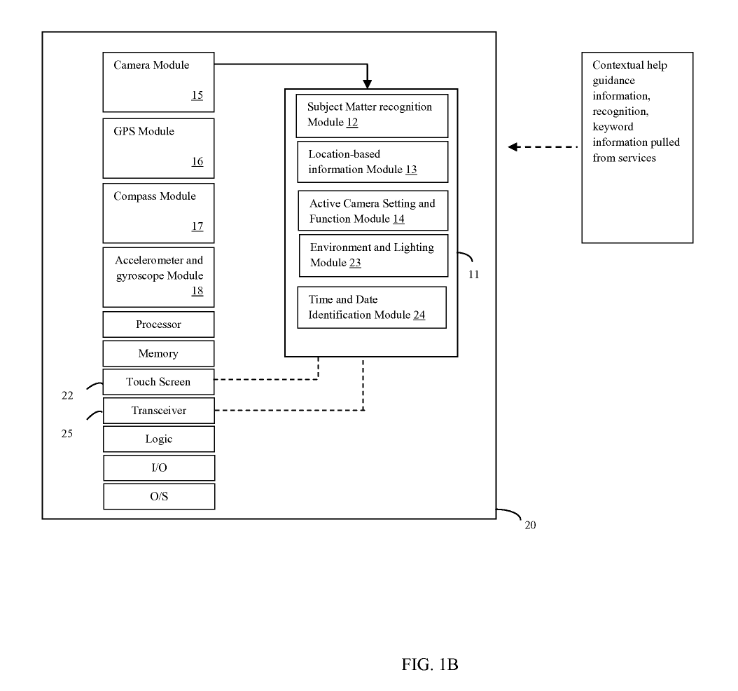

FIGS. 2A-D shows an example progression of user interaction for providing contextual help guidance information for a current framed image for assistance and possible use for assistance in taking a photo of the subject matter currently framed using a camera of the mobile device 20. FIG. 2A shows a current frame viewed on display format 200. In the current frame display format 200, a view of a sports stadium is shown at night. In one embodiment, a contextual help guide icon 220 (FIG. 2B) for selecting and activating the contextual help guidance system 10 is displayed by tapping and dragging down with one's finger on a function icon 210 (e.g., a function wheel icon) using the touch screen 22. FIG. 2B shows the contextual help guide icon 220 being displayed on the display format 200. In one embodiment, the contextual help guidance mode is activated by tapping on the contextual help guide icon 220 using the touch screen 22. In one embodiment, once the contextual help guidance mode is activated, the modules of the contextual guidance module 11 obtain the relevant information based on the subject matter of the current frame, location, active camera settings and function, environment and lighting, and data and time information. Based on the current frame subject matter as illustrated in FIGS. 2A-B, the contextual guidance module 11 determines that the subject matter pertains to a sporting venue at night on a particular date.

FIG. 2C shows a display format 230 showing provided contextual help and guidance display format 230. Based on the information obtained in the current frame, the help and guidance pertains to flash related topics based on low-lighting detected at night at a baseball game. Further help and guidance may be displayed relating to sports related photography. In one example, based on the date, time and location, the names of the teams playing may also be obtained, name of the stadium and guidance related to the stadium may be displayed. In one embodiment, pressing on a button 240 provides for additional keyword search entries or voice activated entries for further related searching for help and guidance.

FIG. 2D shows icons for display on the display format 200 for indicating detection of different contextual information. Icon 250 indicates that time of day has been detected. Icon 260 indicates that the date has been detected. Icon 270 indicates that the subject matter has been detected. In one example, the icons 250, 260 and 270 provide feedback to a user so that the basis for the type of contextual help guidance may be known. Additionally, in one embodiment, the icons 250, 260 and 270 may further be tapped for filtering in/out targeted contextual help and guidance.

In one embodiment, a user aims a camera of a mobile device (e.g., smartphone, tablet, smart device) including the contextual guidance module 11, towards a target object/subject, for example an object, scene or person(s) at a physical location, such as a city center, attraction, event, etc. that the user is visiting and may use for obtaining contextual help and guidance in capturing a photo. The photo from the camera application (e.g., camera module 15) is processed by the mobile device 20 and displayed on a display monitor 21 of the mobile device 20. In one embodiment, the new photo image may then be shared (e.g., emailing, text messaging, uploading/pushing to a network, etc.) with others as desired using the transceiver 25.

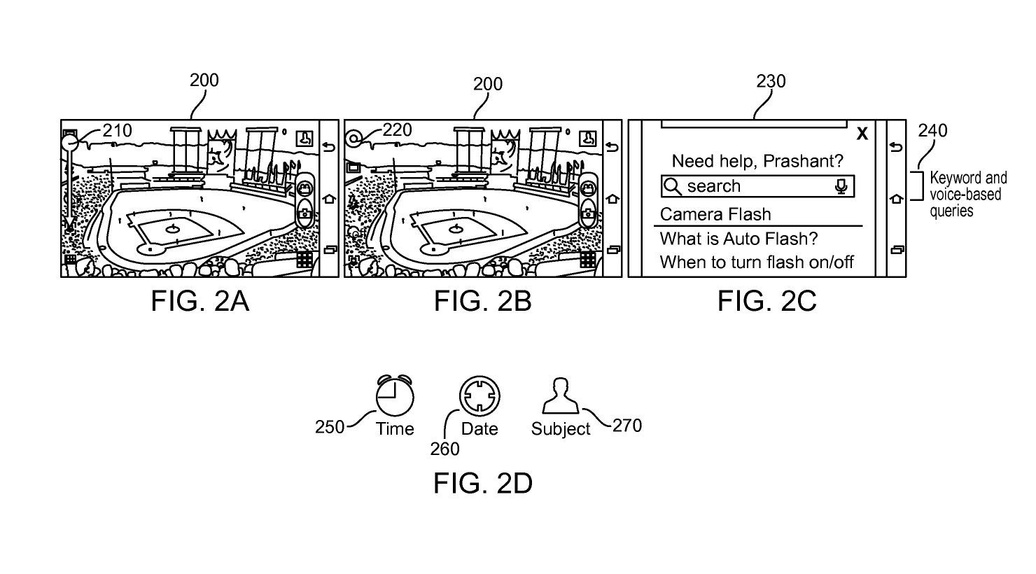

FIG. 3 shows a flowchart of providing contextual help guidance information for camera settings based on a current framed image process 300, according to an embodiment. Process block 305 comprises using an electronic device (e.g., mobile device 20) for turning on or activating a camera. Process block 310 comprises identifying the location and subject matter of a currently framed image. Process block 311 comprises identifying the time of day and date information. Process block 312 comprises identifying the environment and quality of light. Process block 313 comprises determining active camera settings and functions.

Process block 320 comprises activating the contextual help and guidance mode by dragging a function wheel icon down and tapping on a displayed help and guidance icon. Process block 321 comprises launching the help and guidance (e.g., a help hub) application using help and guidance system 10. Process block 330 comprises obtaining contextually sensitive definitions, tips and guidance on a display based on for the currently viewed subject matter in the current frame from stored guidance information 340 stored on a device, cloud environment, network, system, etc., where the retrieved information is pulled to a mobile device. Process block 331 comprises obtaining contextually sensitive image capturing guidance on a display based on for the currently viewed subject matter in the current frame. Process block 332 provides displaying the contextual help and guidance information in a display of a mobile device.

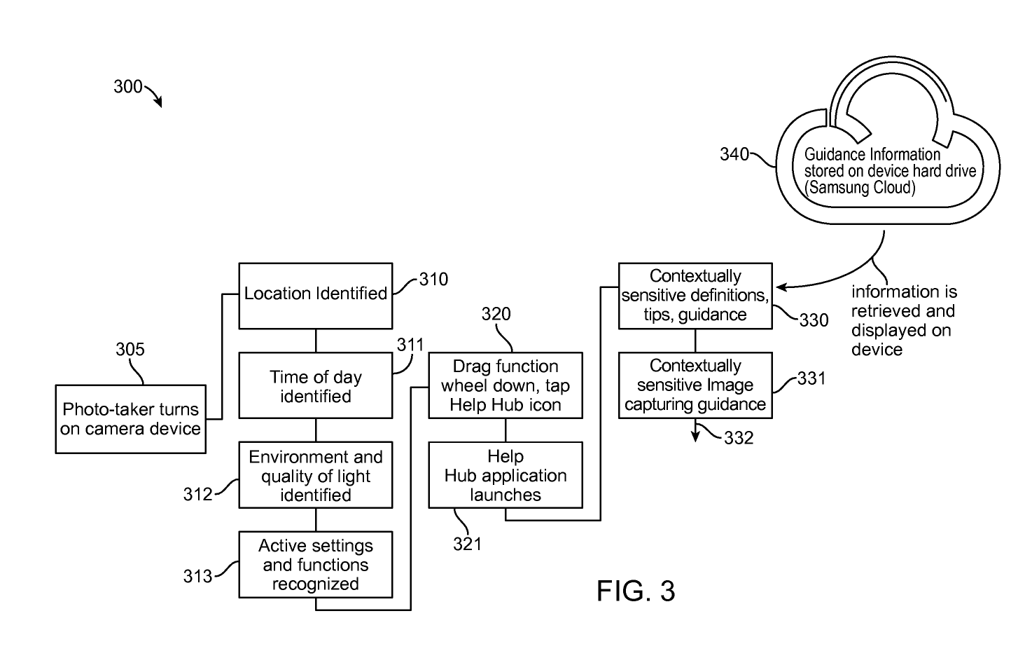

FIG. 4 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one example embodiment, in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes a contextual help guidance module 11 as described herein, according to an embodiment. In one implementation of said contextual help guidance module 11 along an operating system 529 may be implemented as executable code residing in a memory of the system 500. In another embodiment, such modules are in firmware, etc.

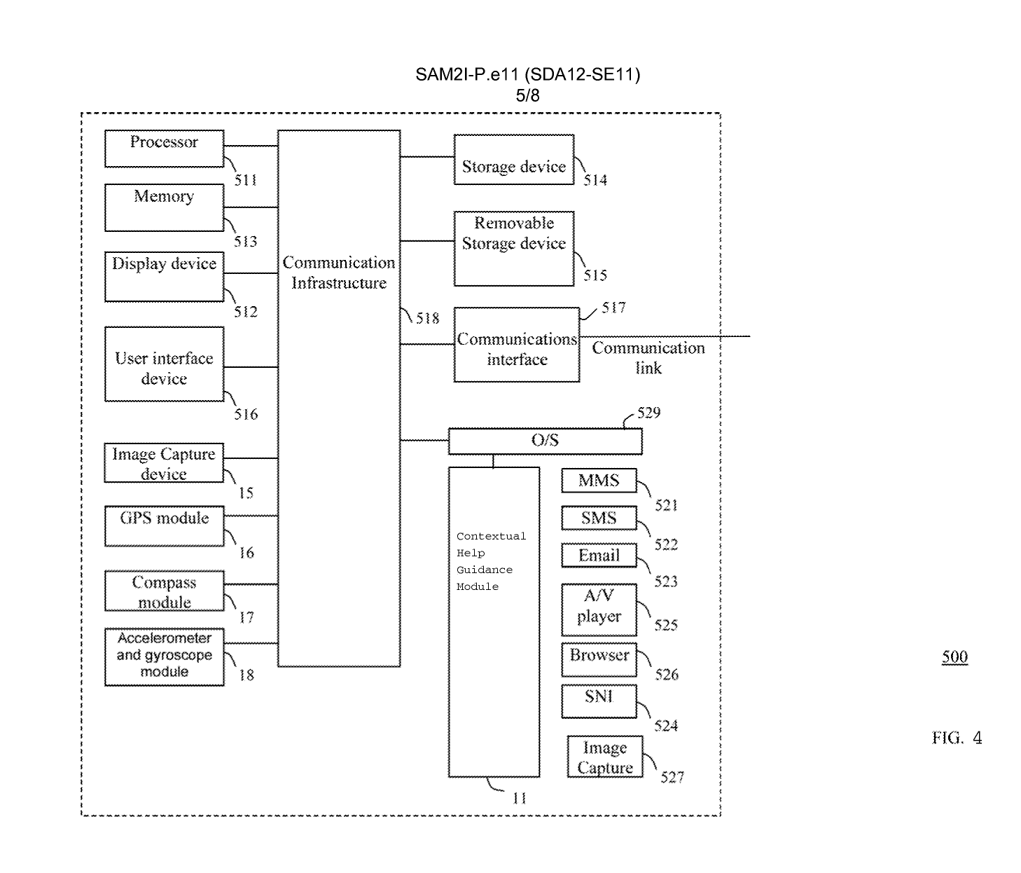

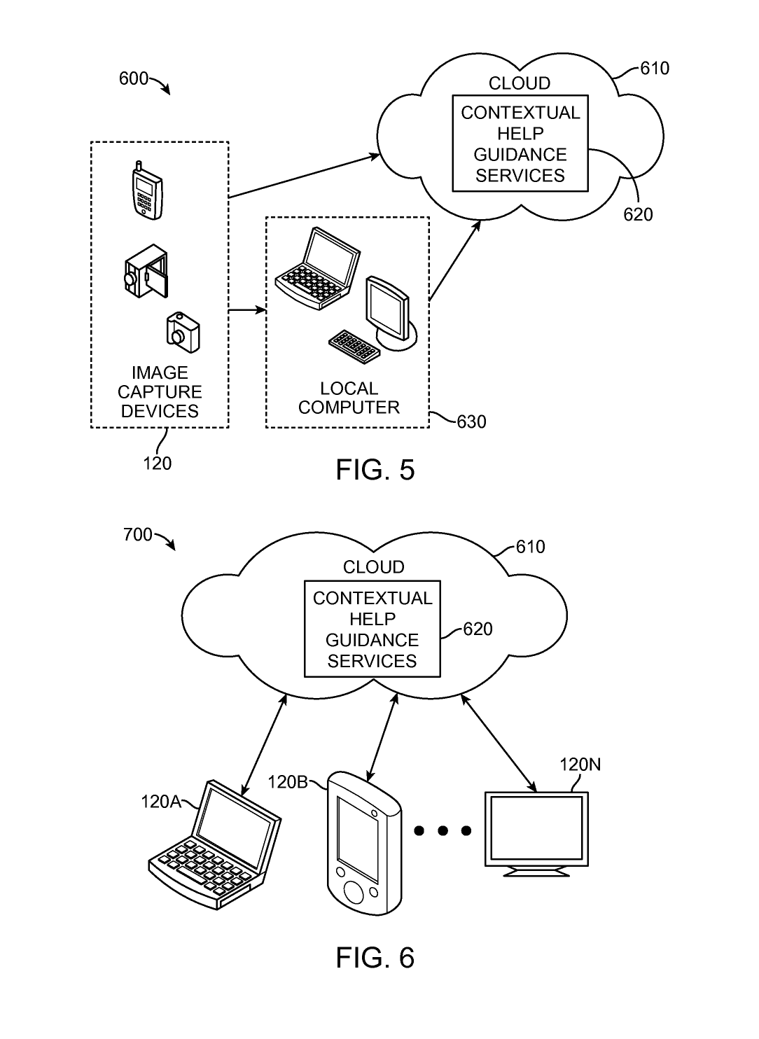

FIGS. 5 and 6 illustrate examples of networking environments 600 and 700 for cloud computing in which contextual help guidance embodiments described herein may utilize. In one embodiment, in the environment 600, the cloud 610 provides services 620 (such as contextual help guidance, social networking services, among other examples) for user computing devices, such as electronic device 120 (e.g., similar to electronic device 20). In one embodiment, services may be provided in the cloud 610 through cloud computing service providers, or through other providers of online services. In one example embodiment, the cloud-based services 620 may include contextual help guidance processing and sharing services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, provide contextual help guidance information, etc. In one embodiment, the electronic devices 120 may upload one or more digital images to the service 620 on the cloud 610 either directly (e.g., using a data transmission service of a telecommunications network) or by first transferring the one or more images to a local computer 630, such as a personal computer, mobile device, wearable device, or other network computing device.

In one embodiment, as shown in environment 700 in FIG. 6, cloud 610 may also be used to provide services that include contextual help guidance embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 600 and 700, any of the embodiments may be implemented at least in part by cloud 610. In one embodiment example, contextual help guidance techniques are implemented in software on the local computer 630, one of the electronic devices 120, and/or electronic devices 120A-N. In another example embodiment, the contextual help guidance techniques are implemented in the cloud and applied to actions, or media as they are uploaded to and stored in the cloud.

In one or more embodiments, media and contextual help guidance is shared across one or more social platforms from an electronic device 120. Typically, the shared contextual help guidance and media are only available to a user if the friend or family member shares it with the user by manually sending the media (e.g., via a multimedia messaging service (“MMS”)) or granting permission to access from a social network platform. Once the contextual help guidance or media is created and viewed, people typically enjoy sharing them with their friends and family, and sometimes the entire world. Viewers of the media will often want to add metadata or their own thoughts and feelings about the media using paradigms like comments, “likes,” and tags of people.

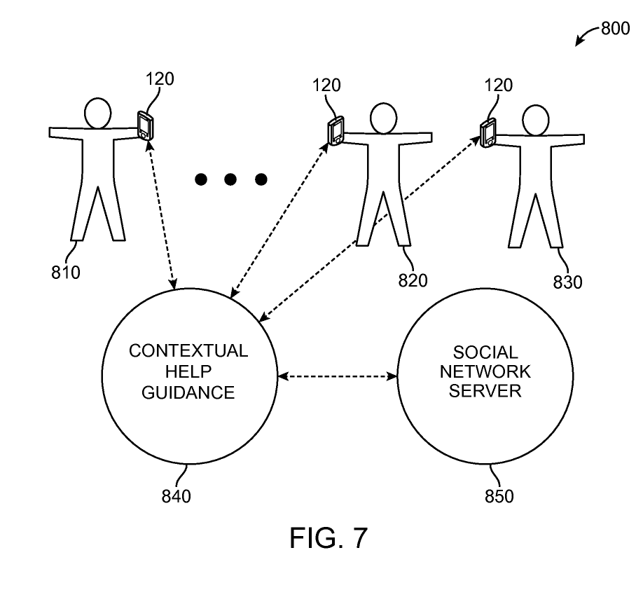

FIG. 7 is a block diagram 800 illustrating example users of contextual help guidance system according to an embodiment. In one embodiment, users 810, 820, 830 are shown, each having a respective electronic device 120 that is capable of capturing digital media (e.g., images, video, audio, or other such media) and providing contextual help guidance. In one embodiment, the electronic devices 120 are configured to communicate with a contextual help guidance controller 840, which is may be a remotely-located server, but may also be a controller implemented locally by one of the electronic devices 120. In one embodiment where the contextual help guidance controller 840 is a remotely-located server, the server may be accessed using the wireless modem, communication network associated with the electronic device 120, etc. In one embodiment, the contextual help guidance controller 840 is configured for two-way communication with the electronic devices 120. In one embodiment, the contextual help guidance controller 820 is configured to communicate with and access data from one or more social network servers 850 (e.g., over a public network, such as the Internet).

In one embodiment, the social network servers 850 may be servers operated by any of a wide variety of social network providers (e.g., Facebook®, Instagram®, Flicker®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the contextual help guidance controller 840 may provide login and password information through an appropriate settings screen. In one embodiment, this information may then be stored by the contextual help guidance controller 840. In one embodiment, a user's private or public social network information may be searched and accessed by communicating with the social network server 850, using an application programming interface (“API”) provided by the social network operator.

In one embodiment, the contextual help guidance controller 840 performs operations associated with a contextual help guidance application or method. In one example embodiment, the contextual help guidance controller 840 may receive media from a plurality of users (or just from the local user), determine relationships between two or more of the users (e.g., according to user-selected criteria), and transmit contextual help guidance information, comments and/or media to one or more users based on the determined relationships.

In one embodiment, the contextual help guidance controller 840 need not be implemented by a remote server, as any one or more of the operations performed by the contextual help guidance controller 840 may be performed locally by any of the electronic devices 120, or in another distributed computing environment (e.g., a cloud computing environment). In one embodiment, the sharing of media may be performed locally at the electronic device 120.

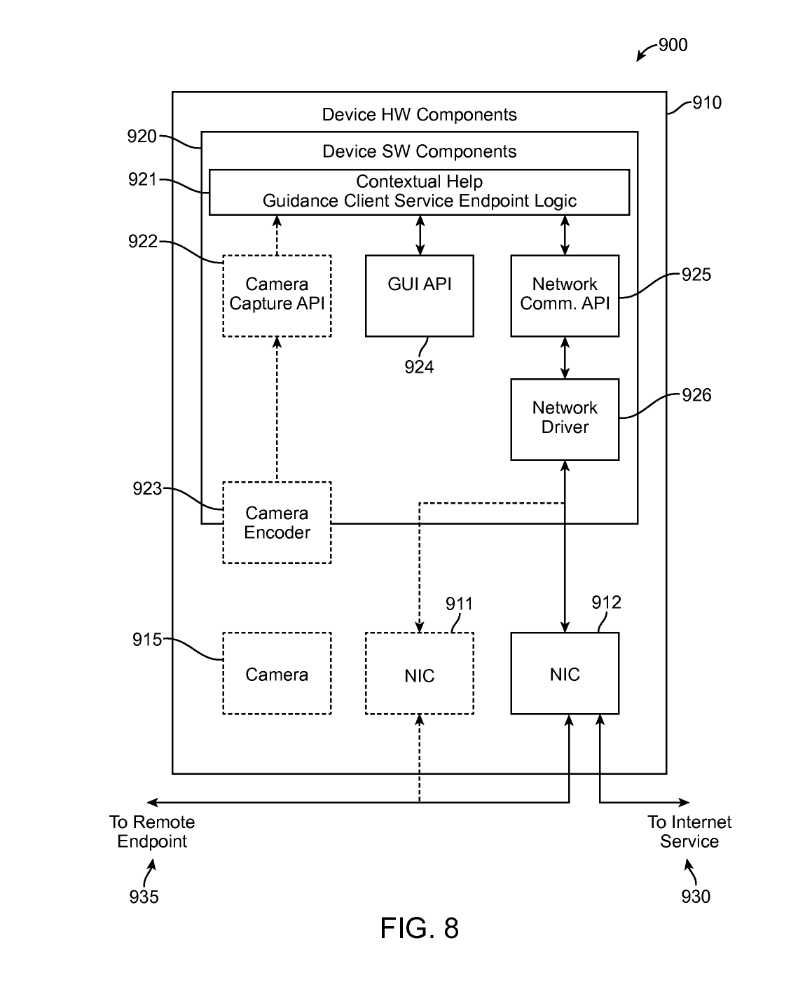

FIG. 8 shows an architecture for a local endpoint host 900, according to an embodiment. In one embodiment, the local endpoint host 900 comprises a hardware (HW) portion 910 and a software (SW) portion 920. In one embodiment, the HW portion 910 comprises the camera 915, network interface (NIC) 911 (optional) and NIC 912 and a portion of the camera encoder 923 (optional). In one embodiment, the SW portion 920 comprises contextual help guidance client service endpoint logic 921, camera capture API 922 (optional), a graphical user interface (GUI) API 924, network communication API 925, and network driver 926. In one embodiment, the content flow (e.g., text, graphics, photo, video and/or audio content, and/or reference content (e.g., a link)) flows to the remote endpoint in the direction of the flow 935, and communication of external links, graphic, photo, text, video and/or audio sources, etc. flow to a network service (e.g., Internet service) in the direction of flow 930.

One or more embodiments, use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's onmessage callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. A method of providing contextual help guidance information for camera settings based on a current framed image, comprising:
displaying a framed image from a camera of an electronic device;
performing contextual recognition for the framed image on a display of the electronic device;
identifying active camera settings and functions of the electronic device; and
presenting contextual help guidance information based on the contextual recognition and active camera settings and functions.

2. The method of claim 1, wherein the contextual recognition comprises:
identifying location information for the electronic device;
identifying time of day information at an identified location; and
identifying environment and quality of lighting at the identified location.

3. The method of claim 2, wherein identifying location information comprises identifying subject matter based on the framed image on the display.

4. The method of claim 3, further comprising:
obtaining the contextual help guidance information from one of a memory of the electronic device and from a network; and
displaying the contextual help guidance information on the display.

5. The method of claim 4, wherein the contextual help guidance information comprises image capturing guidance information.

6. The method of claim 5, wherein the image capturing guidance information comprises one or more of camera photo capturing tips, camera related definitions and camera setting guidance information.

7. The method of claim 4, further comprising activating contextual help guidance by one of a touch screen, keyword query and voice-based query.

8. The method of claim 1, wherein said contextual help guidance information is selectable based on one of time, date and subject matter.

9. The method of claim 1, wherein the electronic device comprises a mobile electronic device.

10. The method of claim 9, wherein the mobile electronic device comprises a mobile phone.

11. An electronic device, comprising:
a camera;
a display; and
a contextual guidance module that provides contextual help guidance information based on a current framed image via a camera of an electronic device;
wherein the contextual guidance module performs contextual recognition for the current framed image on the display, identifies active camera settings and functions of the electronic device, and presents contextual help guidance information based on the contextual recognition and active camera settings and functions.

12. The electronic device of claim 11, wherein the contextual guidance module identifies location information for the electronic device, identifies time of day information at an identified location, and identifies environment and quality of lighting at the identified location.

13. The electronic device of claim 12, wherein the contextual guidance module identifies subject matter based on the current framed image on the display.

14. The electronic device of claim 13, wherein the contextual guidance module obtains the contextual help guidance information from one of a memory of the electronic device and from a network, and displays the contextual help guidance information on the display.

15. The electronic device of claim 13, wherein the contextual help guidance information comprises image capturing guidance information that includes one or more of camera photo capturing tips, camera related definitions and camera setting guidance information.

16. The electronic device of claim 15, wherein said contextual help guidance information is selectable based on one of time, date and subject matter.

17. The electronic device of claim 11, wherein the electronic device comprises a mobile electronic device.

18. A computer program product for providing contextual help guidance information for camera settings based on a current framed image, the computer program product comprising:
a tangible storage medium readable by a computer system and storing instructions for execution by the computer system for performing a method comprising:
displaying a framed image from a camera of an electronic device;
performing contextual recognition for the framed image on a display of the electronic device;
identifying active camera settings and functions of the electronic device; and
presenting contextual help guidance information based on the contextual recognition and active camera settings and functions.

19. The computer program product of claim 18, wherein the contextual recognition comprises:
identifying location information for the electronic device;
identifying time of day information at an identified location; and
identifying environment and quality of lighting at the identified location.

20. The computer program product of claim 19, identifying location information comprises identifying subject matter based on the framed image on the display.

21. The computer program product of claim 20, further comprising:
obtaining the contextual help guidance information from one of a memory of the electronic device and from a network; and
displaying the contextual help guidance information on the display.

22. The computer program product of claim 21, wherein the contextual help guidance information comprises image capturing guidance information, and the image capturing guidance information includes one or more of camera photo capturing tips, camera related definitions and camera setting guidance information.

23. The computer program product of claim 22, wherein said contextual help guidance information is selectable based on one of time, date and subject matter.

24. The computer program product of claim 18, wherein the electronic device comprises a mobile electronic device.

25. A graphical user interface (GUI) displayed on a display of an electronic device, comprising:
a personalized contextual help menu including one or more selectable references related to a framed image obtained by a camera of the electronic device based on one or more of identified location information and object recognition, wherein upon selection of one of the references, information is displayed on the GUI.

26. The GUI of claim 25, wherein the one or more selectable references are displayed as a list on the GUI.
